(19) United States
(12) Patent Application Publication
(10) Pub. No.: US 2024/0260086 A1
(43) Pub. Date: Aug. 1, 2024

(54) METHOD AND SYSTEM FOR ACCESS POINTS IN A WIRELESS NETWORK TO SHARE SERVICE PERIODS OF A TRANSMIT OPPORTUNITY (TXOP)

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/427,100

(22) Filed: Jan. 30, 2024

Related U.S. Application Data
(60) Provisional application No. 63/482,581, filed on Jan. 31, 2023.
(60) Provisional application No. 63/483,995, filed on Feb. 9, 2023.

(51) Int. Cl. H04W 74/0816; H04W 72/0446

(52) U.S. Cl. CPC H04W 74/0816; H04W 72/0446

(57) ABSTRACT

A method and system for a sharing access point (AP) to allocate one or more service periods of a transmit opportunity (TXOP) time to one or more shared AP. In an example, the sharing AP transmits one or more multi-user request to send TXOP sharing (MU-RTS TXS) frames to the one or more shared AP to indicate the allocation to the one or more shared AP and receives a respective clear to send (CTS) from the one or more shared AP in response to a corresponding MU-RTS TXS frame to indicate a confirmation by a respective shared AP which will use the allocated service period of the TXOP. The shared AP then performs one or more of a downlink transmission and uplink reception in the allocated service period.

### RELATED APPLICATION

This application claims a benefit of priority to U.S. Provisional Application No. 63/482,581, filed Jan. 31, 2023 and U.S. Provisional Application No. 63/483,995, filed Feb. 9, 2023, the contents each of which are incorporated herein by reference in their entireties.

### FIELD OF USE

This disclosure generally relates to wireless communication, and more particularly to access points (AP) in a wireless network sharing service periods of a transmit opportunity (TXOP) associated with a sharing AP.

### BACKGROUND

In wireless communications, an access point (AP), wirelessly transmits frames in a transmit opportunity (TXOP). The TXOP defines a time duration for which the access point sends frames after it has gained contention for a transmission medium. A basic service set (BSS) in a wireless network includes an AP and one or more client stations (STAs) which communicate with the AP. Institute of Electrical and Electronics Engineers (IEEE) 802.11be describes an AP sharing a service period of the TXOP with the client stations for uplink communication with the AP and peer-to-peer (P2P) non-trigger based frame exchange. IEEE 802.11be also defines a multi-user request to transmit TXOP sharing (MU-RTS TXS) frame to enable the sharing with the STA.

### BRIEF DESCRIPTION OF THE DRAWINGS

The drawings are for the purpose of illustrating example embodiments, but it is understood that the embodiments are not limited to the arrangements and instrumentality shown in the drawings.

FIG. 1 depicts an example wireless network in accordance with an embodiment.

FIG. 2 illustrates various examples of sharing of the TXOP by the sharing AP with one or more shared AP in accordance with an embodiment.

FIG. 3 illustrates example fields of a MU-RTS TXS to indicate the sharing of the TXOP in accordance with an embodiment.

FIG. 4 illustrates an example of an operating bandwidth of the sharing AP and shared AP in accordance with an embodiment.

FIG. 5 illustrates another example of an operating bandwidth of the sharing AP and shared AP in accordance with an embodiment.

FIG. 6 illustrates an example of channel use in presence of puncturing in accordance with an embodiment.

FIG. 7 illustrates another example of channel use in presence of puncturing in accordance with an embodiment.

FIG. 8 illustrates a flow chart of functions associated with sharing of the TXOP in accordance with an embodiment.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to a method and system for a sharing AP to share a transmit opportunity time (TXOP) of the sharing AP with one or more shared APs. The sharing AP allocates one service period of the TXOP to one shared AP. Alternatively, the sharing AP allocates one service period to more than one shared APs. In the case one service period is allocated to a plurality of shared APs, a primary channel switch is performed for shared APs with a same primary channel to avoid overlap in the same primary channel. The sharing AP indicates the sharing with the one or more shared AP by a multi-user request to transmit TXOP sharing (MU-RTS TXS) frame which identifies one or more of the shared AP, a resource unit (RU) for the shared AP to transmit frames, and a service period in the TXOP which is shared with the shared AP. Further, a clear to send (CTS) transmitted by the shared AP in response to the MU-RTS TXS indicates the confirmation of the shared AP which will use the allocated service period of the TXOP. Well known instructions, protocols, structures, and techniques have not been shown in detail in order not to obfuscate the description.

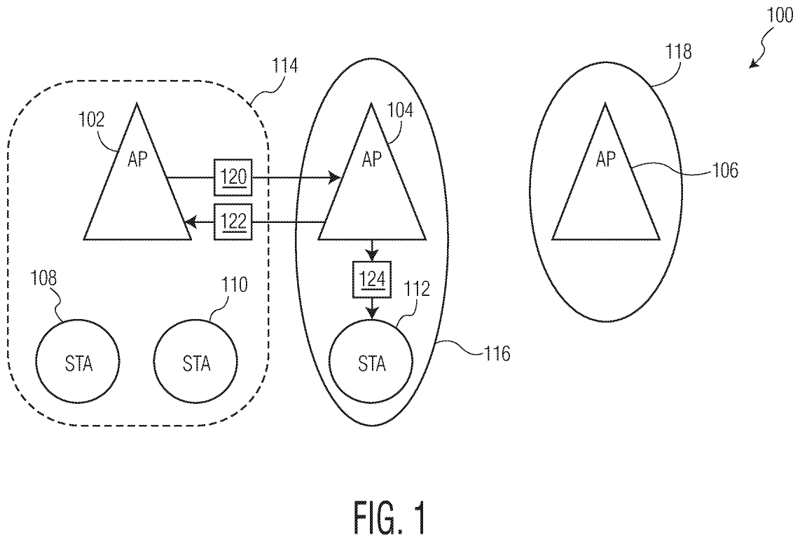

FIG. 1 depicts an example wireless network 100 in accordance with an embodiment. The wireless system 100 includes one or more wireless devices such as one or more access points (APs) 102-106 and one or more client stations (STAs or non-AP STAs) 108-112 that operate based on the Institute of Electrical and Electronics Engineers (IEEE) 802.11 standard. For example, the wireless system 100 may be compatible with an IEEE 802.11 specification such as IEEE 802.11ac, IEEE 802.11ax, IEEE 802.11be, and IEEE 802.11bn. IEEE 802.11ac is referred to as a very high throughput (VHT). IEEE 802.11ax is referred to as high efficiency (HE). IEEE 802.11be is referred to as extreme high throughput (EHT). IEEE 802.11bn is referred to as ultra-high reliability (UHR). The wireless system 100 may have fewer or more APs or STAs than as illustrated. The STA may be an end device which wirelessly communicates with an AP while the AP may allow connections by nearby associated devices such as STAs to a wired network such as the Internet. In some examples, each AP may be affiliated with a respective AP multi-link device (MLD) and the STA may also be affiliated with a non-AP MLD.

A basic service set (BSS) defines a network topology which includes an AP and one or more STA associated with the AP. The AP and STA may be associated based on an association process defined by IEEE 802.11. In an example, AP 102 and STA 108-110 may associated and define a basic service set (BSS) 114 and AP 104 and STA 112 may be associated and define another BSS 116. BSS information of the BSS may include capabilities and operating parameters of the BSS set up by an AP of the BSS such as one or more of an BSS operating bandwidth, BSS operating channel, and a BSS identification (BSSID) such as a media access communication (MAC) address of the access point 102 in the BSS 114. The BSS operating channel may define 20 MHz channels used by the AP or STA in the BSS and the BSS operating bandwidth may define a bandwidth used by the AP or STA in the BSS. In an example, the AP 102 or AP 104 may transmit a management frame such as a beacon frame or action frame to the associated STAs to announce presence of the BSS and the BSS information.

In an example, a neighbor in the wireless system 100 may be defined as a wireless device which is in a communication range of another wireless device. For example, an AP may be a neighbor of another AP if the AP is able to receive a frame from the other AP with an acceptable signal strength while if the AP is not able to receive the frame from the other AP with an acceptable signal strength then the AP may not be a neighbor of the other AP. As another example, an AP may be a neighbor of an STA if the STA is able to receive a frame from the AP with an acceptable signal strength while if the STA is not able to receive the frame from the AP with an acceptable signal strength then the STA may not be a neighbor of the AP. The neighbors are illustrated in the wireless system 100 as being proximate to each other and are associated with overlapping BSS (OBSS). For example, AP 102 and AP 104 in BSS 114 and BSS 116 respectively may be neighbors and in OBSS while AP 106 in BSS 118 may not be a neighbor to AP 102 in BSS 114 and not in OBSS. Other variations are also possible.

In wireless communications, wireless devices, e.g., Access Points (APs), wirelessly transmit frames in a transmit opportunity (TXOP). The TXOP defines the time duration which the AP may send frames after the AP has gained contention of a transmission medium. An AP may share a portion of the TXOP with another AP such as a neighbor AP, referred to as a service period. In this example, the AP which shares the service period of the TXOP may be a sharing AP and the AP which uses the service period(s) of the TXOP to transmit frames may be the shared AP. The sharing AP may indicate the TXOP sharing to the shared AP by a multi-user request to transmit a TXOP sharing (MU-RTS TXS) frame (also referred to as MU-RTS TXS). The MU-RTS TXS may indicate one or more of the shared AP with which the TXOP will be shared, a resource unit (RU) for a shared AP to transmit frames, and a service period of the TXOP which is shared with the shared AP. For example, the sharing AP 102 may transmit a MU-RTS TXS 120 to the shared AP 104 to share a service period of a TXOP with the shared AP 104. Further, a clear to send (CTS) 122 transmitted by the shared AP in response to the MU-RTS TXS indicates the confirmation of the shared AP which will use the service period of the TXOP. For example, the shared AP 104 may transmit a CTS 122 in response to the MU-RTS TXS 120 transmitted by the sharing AP 102. The shared AP may then transmit during the service period of the TXOP a trigger based physical layer convergence protocol data unit (TB-PPDU) 124 to the STA 122.

The AP may communicate with the STA via one channel in a bandwidth, referred to as the operating channel. The operating channel may be contiguous 20 MHz channels in the bandwidth each bounded by a low frequency and a high frequency. Further, the operating channel may cover a primary 20 MHz channel and additional secondary 20 MHz channels for transmitting data and management frames. In an example, the primary 20 MHz channel of the shared AP shall be within the BSS operating channel of the sharing AP and is not a punctured 20 MHz channel of the sharing AP's BSS operating channel. In an example, the primary 20 MHz channel of the sharing AP shall be within the BSS operating channel of the shared AP and is not a punctured 20 MHz channel of the shared AP's BSS operating channel. In some situations, the primary channel of the sharing AP might be the same as the primary channel of the shared AP. If the primary channel of the sharing AP and shared AP are the same, then the primary channel of the shared AP is switched to avoid overlapping primary channels in frequency by both the sharing AP and shared AP when a service period is used by both the sharing AP and shared AP in different operating channels.

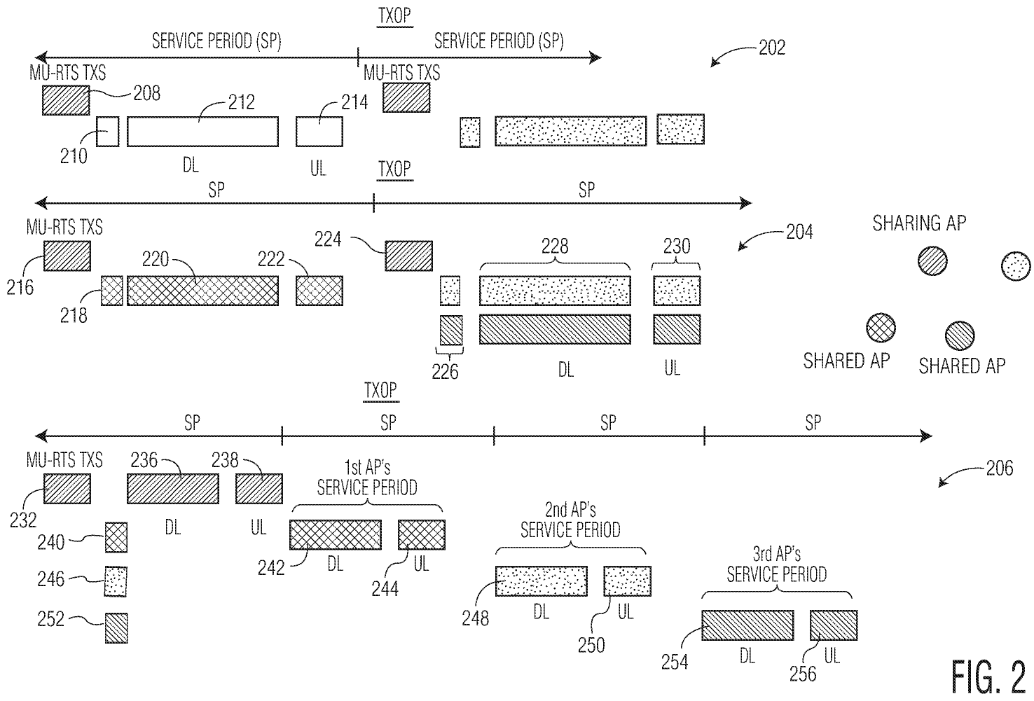

FIG. 2 illustrates various examples 202-206 of sharing of the TXOP by the sharing AP with one or more shared AP in accordance with an embodiment. The sharing may be indicated by a sharing AP transmitting an MU-RTS TXS which indicates one or more service periods of the TXOP which is shared. The MU-RTS TXS may be transmitted in a physical layer protocol data unit (PPDU). The shared AP which receives the MU-RTS TXS with the TXOP to be shared responds with a clear to send (CTS) response to the sharing AP to indicate the confirmation that the shared AP will use the service period for transmitting a PPDU. The shared AP may then transmit a downlink (DL) multiuser/single user (MU/SU) PPDU in a downlink communication and/or receive a PPDU in an uplink communication from one or more associated STA in response to the DL PPDU.

In one example 202 (basic mode), the sharing AP transmits an MU-RTS TXS 208 to allocate one service period of a TXOP to one shared AP. The shared AP may transmit a CTS 210 followed by transmission of one or more of a downlink PPDU 212 and receipt of an uplink PPDU 214 in the service period. To allocate another service period of the TXOP, the sharing AP transmits another MU-RTS TXS to another shared AP followed by the shared AP transmitting a CTS and one or more of transmitting a downlink PPDU and receiving an uplink PPDU.

In another example 204 (enhanced mode), the sharing AP transmits MU-RTS TXS 216 to allocate a service period of a TXOP to one or more shared AP. The sharing AP may transmit a MU-RTS TXS 216 to allocate a service period of the TXOP to one shared AP. The shared AP may transmit a CTS 218 followed by transmission of one or more of a downlink PPDU 220 and receipt of an uplink PPDU 222 in the service period. In another service period, the sharing AP may transmit a MU-RTS TXS 224 to allocate a time period of the TXOP to more than one shared AP. The shared APs may transmit a respective CTS 226 followed by respective transmission of one or more of a downlink PPDU 228 and receipt of an uplink PPDU 230 in the service period.

In yet another example 206, the sharing AP transmits an MU-RTS TXS 232 to allocate multiple service periods of a TXOP to one or more shared AP or the sharing AP. The sharing AP may transmit a MU-RTS TXS 232 to allocate the multiple service period of the TXOP where each service period is allocated to one shared AP or the sharing AP. The sharing AP may transmit one or more of a downlink PPDU 236 and receive an uplink PPDU 238 in the service period. Each shared AP may transmit a respective CTS 240, 246, 252 followed by transmission of one or more of a downlink PPDU and receipt of an uplink PPDU shown as one of PPDU 242, 244, 248, 250, 254, 256 in a respective service period. In some examples, the shared APs that will be scheduled in the TXOP will simultaneously transmit data to a receiving terminal between them.

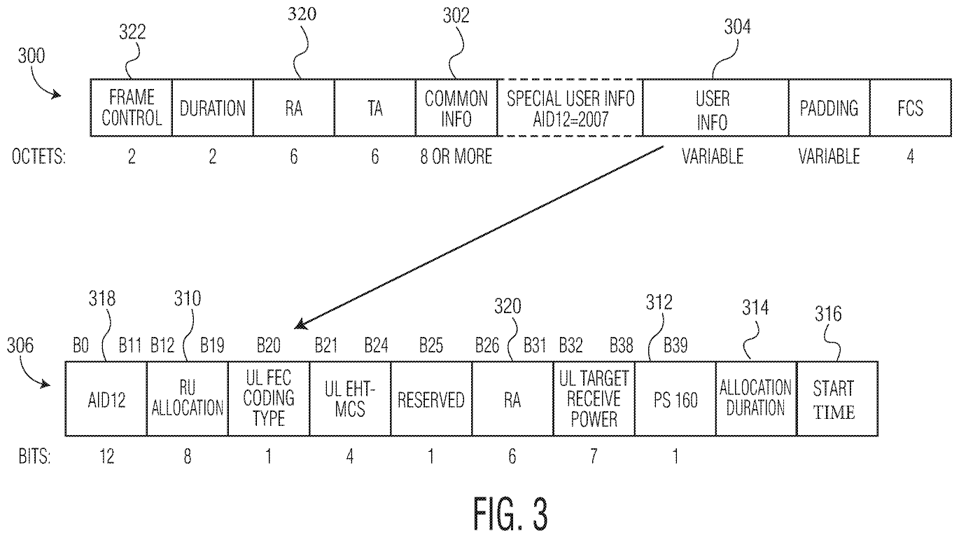

FIG. 3 illustrates example fields of the MU-RTS TXS 300 to indicate the sharing of the TXOP in accordance with an embodiment. The MU-RTS TXS 300 may be a control frame. The MU-RTS TXS 300 includes a Common Information (Common Info) field 302 and one or more User Information (User Info) field 304. The common information field 302 indicates common information transmitted to the recipient(s) and each User Info field in the user information field(s) 304 indicates information specific to a recipient. In one embodiment, the MU-RTS TXS only addresses to one recipient that is a shared AP and a sharing AP may transmit to a shared AP the MU-RTS TXS 300 to share one service period of the TXOP with the shared AP (basic mode). In another embodiment, the MU-RTS TXS addresses to multiple recipients that are the shared APs and a sharing AP may transmit to the shared APs the MU-RTS TXS 300 to share one service period of the TXOP with the shared APs (enhanced mode). In third embodiment, the MU-RTS TXS addresses to multiple recipients that are the shared APs and a sharing AP may transmit to the shared APs the MU-RTS TXS 300 to share multiple service periods of the TXOP with the shared APs. The MU-RTS TXS 300 may allocate resources to the shared AP which may include a service period of the TXOP and resource unit (RU) on which the shared AP does the frame exchanges with its associated STAs.

In one example, each User Info field of the User Info field(s) 304 of the MU-RTS TXS may include subfields 306 including an Allocation Duration field 314 to define a time allocated by the sharing AP to the shared AP for transmitting a PPDU and receiving a PPDU. The allocated time may be a service period which is a specified time window within the TXOP when the shared AP is able to transmit the PPDU and receive the PPDU. In an example, the allocated time may begin at an end of the PPDU carrying the MU-RTS TXS. In another example, the allocated time may begin short interframe space (SIFS) after the end of the PPDU carrying the MU-RTS TXS. In yet another example the allocated time begins at the end of the PPDU carrying a responding frame solicited by the MU-RTS TXS. The responding frame may be a clear to send (CTS) sent in response to the MU-RTS TXS which acknowledges the MU-RTS TXS. In another example, the allocated time begins SIFS after the end of the PPDU carrying the responding frame solicited by the MU-RTS TXS.

In an example, the subfield 306 may include an RU Allocation field 310 to indicate the RU of the AP that is allocated to the shared AP. The RU that is allocated may be within a frequency range of the PPDU carrying the MU-RTS TXS and bandwidth of the PPDU carrying the MU-RTS TXS. The RU allocation field 310 may indicate a size of the RU that cover one or multiple 20 MHz channels (e.g., number of subcarriers of the RU allocated to the shared AP) and the RU location in the bandwidth of the MU-RTS TXS where the RU is allocated. A PS160 field 312 may indicate whether the allocated RU is in the primary 160 MHz bandwidth of the shared AP or not. Further, an RU allocated to a shared AP may span a frequency of the primary 20 MHz channel of the shared AP. A MU-RTS TXS frame may include multiple User Info fields associated with the multiple shared APs. In this case, all User Info fields for different shared AP may have same values in respective Allocation Duration fields and the RU Allocation field and PS160 field of different User Info fields associated with different shared APs indicate the RUs allocated to each of the shared APs within the bandwidth and frequency of the PPDU carrying the MU-RTS TXS. In an example, one RU may span a frequency of the primary 20 MHz channel of the sharing AP. In another example, an RU allocated to a shared AP may span a frequency of the primary 20 MHz channel of the shared AP if the shared AP doesn't negotiate a primary channel switch with the sharing AP. In yet another example, an RU allocated to a shared AP may span a frequency of a switched primary 20 MHz channel of the shared AP if the shared AP negotiates the primary channel switch with the sharing AP. If a MU-RTS TXS frame includes one User Info field being addressed to a shared AP, the RU defined by RU Allocation field and PS160 field of User Info field may span a frequency of the primary 20 MHz channel of the sharing AP.

In another example, a sharing AP may use an MU-RTS TXS to allocate one or more service periods of a TXOP where each service period is allocated to one shared AP or more than one shared AP. In one example, a User Info field of the MU-RTS TXS may include the Allocation Duration field 314 and a Start Time field 316. The Allocation Duration field 314 is defined above and the Start Time field 316 may define the start time of the service period being allocated to the shared AP within the TXOP compared to other shared APs which are also allocated respective service periods. In an example, the start time may begin at an end of the PPDU carrying the MU-RTS TXS. In another example, the start time may begin SIFS after the end of the PPDU carrying the MU-RTS TXS. In yet another example the start time may begin at the end of the PPDU carrying a responding frame solicited by the MU-RTS TXS. In another example, the start time may begin SIFS after the end of the PPDU carrying the responding frame solicited by the MU-RTS TXS. In another example, the start time for one shared AP may start at the end time of the service period allocated to another shared AP. In another example, the User Info field may include an RU Allocation field 310 and PS160 field 312 to indicate the RU of the shared AP which is within a bandwidth and frequency of the PPDU carrying the MU-RTS TXS. An RU allocated to a shared AP will span a frequency of the primary 20 MHz channel of the shared AP.

The subfields 306 of User Info field 304 may also have an AID12 field 318. The AID12 field 318 may identify the shared AP. When the MU-RTS TXS indicates TXOP sharing with more than one shared AP in one or more service periods, dedicated AID values from an AID space may be used to identify the shared APs. When the MU-RTS TXS indicates TXOP sharing with a single shared AP in a single service period, the AID12 field 318 may be set to 0 (reserved) and the shared AP may ignore contents in the AID12 field 318 in the User Info field. The shared AP may be instead be indicated by a receiver address (RA) field 320 of the MU-RTS TXS set to the BSSID of the single shared AP.

In an example, when an AP is the shared AP of different sharing APs, the shared AP can have different AIDs and each AID value is allocated by a respective sharing AP. In another example, within a group of shared APs, each shared AP may have one AID value and the different shared APs within the group have different AID values. Further, a group AP owner may assign the AP AID value for the APs in the group. In yet another example, each shared AP may randomly choose its AID at a booting time and advertise its shared AP AID in each broadcasting beacons, probe response etc. To avoid use of duplicate AIDs, each shared AP may passively listen to neighbor APs' beacons and probe responses to avoid choosing the AP AIDs already being allocated to another shared AP. If a shared AP detects more than one shared APs are advertising the same AP AID value, the shared AP will send unicast notification management frame to the respective shared APs to trigger them to restart the random selection process to choose an unique shared AP AID.

In an example, a sharing AP indicates the RU allocated to a shared AP in an MU-RTS TXS based on a bandwidth of a sharing AP's PPDU carrying the MU-RTS TXS. In one embodiment, the bandwidth of the PPDU carrying the MU-RTS TXS is no wider than the BSS operating bandwidth (BW) of the sharing AP. In another embodiment, the bandwidth of the PPDU carrying the MU-RTS TXS is no wider than the BSS operating BW of the shared AP. The shared AP may also use the 20 MHz channels that are within a frequency of its operating channel and not within a frequency of the RU defined by the User Info field addressed to it to transmit the PPDU or the shared AP may not use the 20 MHz channels that are not within a frequency of its operating channel. Alternatively, the User Info field 304 may explicitly indicate whether such usage is allowed or not. In another example, the sharing AP may indicate the RU allocated to a shared AP in the MU-RTS TXS (or the other new defined frame for resource allocation) based on the shared AP's operating channel. In yet another example, the shared AP may use the 20 MHz channels which are not within a frequency of the operating channel of the sharing AP based on a dynamic bandwidth signaling mechanism initiated by the shared AP. The sharing AP and shared AP may have different bandwidth capabilities. For example, the shared AP may have a wider operating bandwidth than the sharing AP. The bandwidth capability of the shared AP within the TXOP sharing mode may be leveraged in various ways.

In an example, a shared AP notifies its operating bandwidth to the sharing AP through sending unicast Action frame to the sharing AP. In another example, a sharing AP acquires the shared AP's operating bandwidth through receiving the shared AP's Beacon. In yet another example, a sharing AP uses its bandwidth capability instead of its operating bandwidth to transmit the soliciting frame (e.g. MU-RTS TXS) that allocates the service period to the shared AP if the sharing AP's operating bandwidth is narrower than the shared AP's operating bandwidth. The bandwidth capability may be a range of bandwidth which the sharing AP is capable of operating rather than a bandwidth in which the sharing AP is currently operating.

In an example, within the service period allocated by the sharing AP to a shared AP through the soliciting frame, the shared AP may use the wider bandwidth than the bandwidth of the PPDU carrying the soliciting frame. In order to use the wider bandwidth, the shared AP may check that a medium is idle/busy before it's usage of wider bandwidth at least for the 20 MHz channels not within a frequency of the soliciting frame. The inter-frame space before the shared AP's first transmission can be more than SIFS, e.g. point coordination function interframe space (PIFS) for the medium busy/idle checking or SIFS for the medium busy/idle checking. Another variant is that within the time allocated by the sharing AP through the soliciting frame, the shared AP may use a bandwidth no wider than the bandwidth of the PPDU carrying the soliciting frame.

In an example, the sharing AP uses a bandwidth no wider than its current operating bandwidth. Within the time allocated by the sharing AP through the soliciting frame, the shared AP uses the bandwidth no wider than the bandwidth of the PPDU carrying the soliciting frame which is the MU-RTS TXS.

In an example, if a shared AP is not able to use all the medium time (e.g., service period) allocated by the sharing AP, the shared AP may release the unused medium time back to the sharing AP. The explicit indication of the release may be carried by an HE Control field of a frame sent by the shared AP which is transmitted from the shared AP to the sharing AP after any downlink or uplink PPDU.

Before the sharing AP sends the MU-RTS TXS solicitation to the shared AP to share the TXOP, the shared AP may request resources from the sharing AP to transmit frames without the solicitation from the sharing AP. In an example, the shared AP may request a medium time and a BW from the sharing AP without the solicitation from the sharing AP. The request may be carried in a HE Control field of a Quality of Service (QoS) Null frame. Content of the resource request information may include one or more of a medium time that is requested, the bandwidth under which the medium time is requested, or a request in terms of a buffered frame size in octets. Other information may include latency related parameters of one or more of a first frame and last frame to transmit (e.g., lifetime of a frame which is a time after which a frame to be transmitted needs to be discarded and delay bound of a frame which is a time after which a quality of service (QoS) of the frame cannot be satisfied) that the sharing AP uses to determine a timing for allocating the resource.

In another example, a sharing AP may solicit the resource request from the shared AP. A soliciting frame can be a variant of a trigger frame such as a buffer service request poll (BSRP) frame which results in a buffer status report frame transmitted by a shared AP. For example, SIFS after the soliciting, the shared AP reports its resource request in unicast PPDU (MU PPDU with single RU) or SIFS after the soliciting, the shared AP reports its resource request in an UHR/EHT/HE SU PPDU. In another embodiment, the shared AP uses a trigger based (TB) PPDU to send the responding frame with resource request after receiving the soliciting frame.

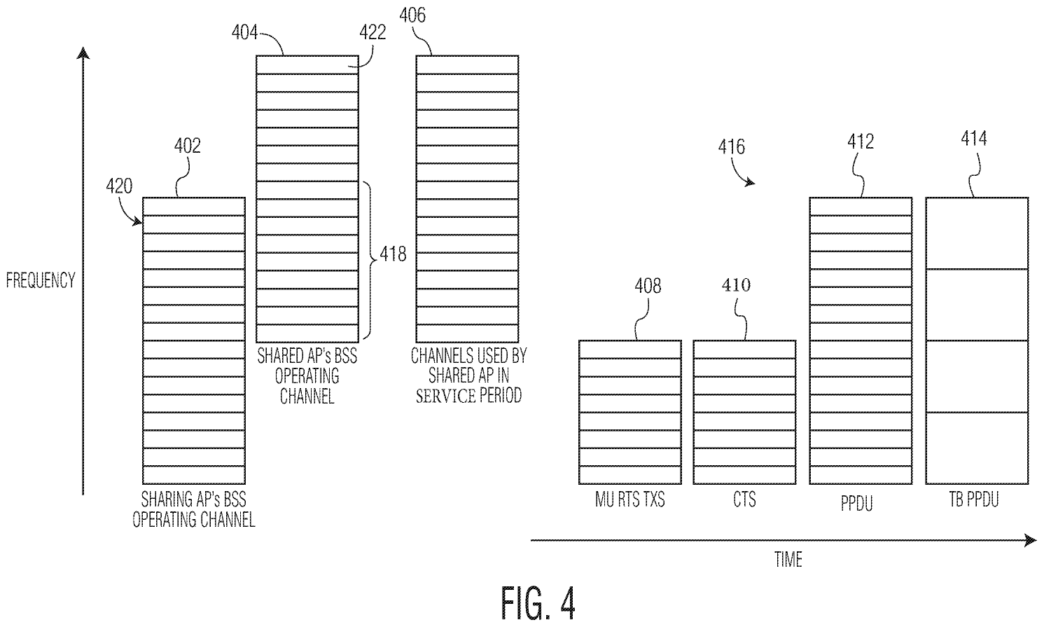

FIG. 4 illustrates an example of an operating bandwidth of the sharing AP and shared AP in accordance with an embodiment. The sharing AP and the shared AP may have different BSS operating channel and a frequency range of a BSS operating channel 402 of the sharing AP may overlap with a frequency range of the BSS operating channel 404 of the shared AP by overlap 418 but not completely overlap. The BSS operating channel 402 of the shared AP may be subdivided into 20 MHz channels, an example of which is illustrated as channel 420. The BSS operating channel 404 of the sharing AP may be subdivided into 20 MHz channels, an example of which is illustrated as channel 422. The BSS operating channel may be a channel in which an AP transmits frames in the BSS which is 320 MHz. In an example, a 320 MHz sharing AP and the 320 MHz shared AP have 160 MHz channel overlapped with each other as shown by the overlap 418 in a frequency domain. If the sharing AP allocates part of its TXOP to the shared AP, the shared AP will use its 320 MHz of channels for its frame exchanges which is indicated by the BSS operating channel 406. In an example, if the BSS operating channel of the sharing AP does not span a frequency of the BSS operating channel of the shared AP and the shared AP performs the frame exchanges with its associated STAs in the service period, the shared AP can use its whole operating channel during the service periods of the TXOP. The shared AP may be allowed to use its BSS operating channel 406, provided its sub-20 MHz channels not overlapping with the sharing AP are clear based on a clear channel assessment (CCA) and the use does not interfere with RU allocation with the other shared AP's RU where the shared APs have the same time allocation (the allocated time by sharing AP of the shared APs have the same start time and end time) or overlapped time allocation (the allocated time of one shared AP does not end while another shared AP's allocated time starts).

Timing diagram 416 shows the PPDU transmitted to share the TXOP. The sharing AP may transmit a PPDU 408 having an MU-RTS TXS which is duplicated in the 20 MHz channels (e.g., PPDU 408 is a non-HT duplicate PPDU) which are overlapping 418 followed by the shared AP transmitting a PPDU 410 having a CTS in response to the MU-RTS TXS duplicated in each channel (e.g., PPDU 410 is also a non-HT duplicate PPDU). The CTS may indicate that the shared AP is ready to use the shared service period. Based on the service period indicated in the MU-RTS TXS, the shared AP may transmit a PPDU 412 with a trigger frame in each channel of the BSS operating channel of the shared AP during the indicated service period and receive a TB PPDU 414 in the BSS operating channel also during the shared service period.

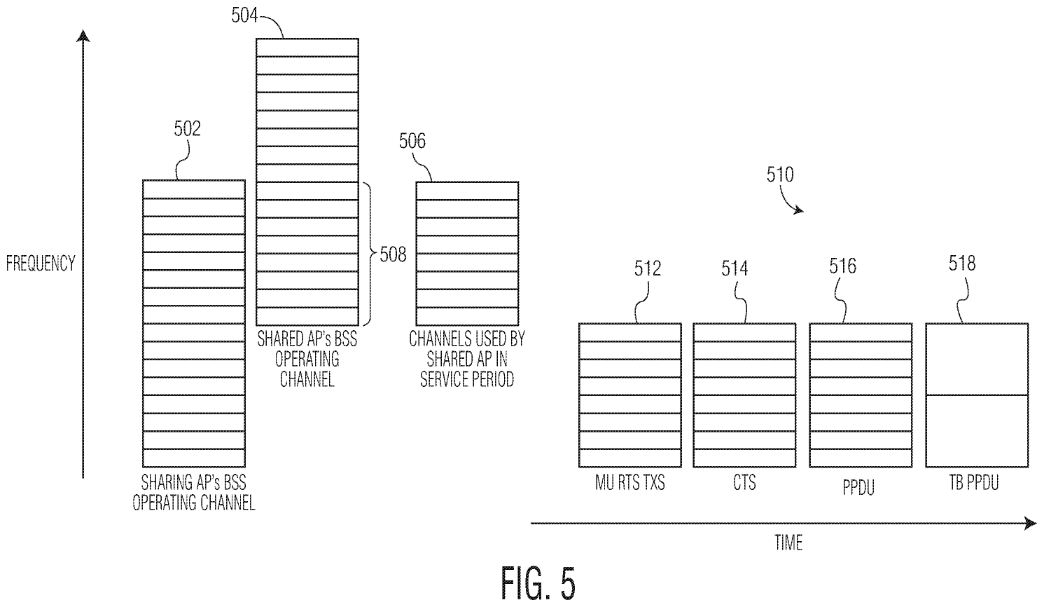

FIG. 5 illustrates another example of an operating bandwidth of the sharing AP and shared AP in accordance with an embodiment. The sharing AP and the shared AP may have different BSS operating channel and a frequency range of a BSS operating channel 502 of the sharing AP may overlap with a frequency range of the BSS operating channel 504 of the shared AP shown by overlap 508 but not completely overlap. The BSS operating channel of an AP may be the one or more 20 MHz channels used by the AP for transmission. In an example, both the 320 MHz operating bandwidth sharing AP and the 320 MHz operating bandwidth shared AP may have the overlap 508 of 160 MHz with each other. If the sharing AP allocates part of its TXOP to the shared AP, the shared AP may use operating channel 506 which is 160 MHz for its frame exchanges. If the BSS operating channel of the sharing AP does not span a frequency of the BSS operating channel of the shared AP and the shared AP does the frame exchanges with its associated STAs in the time, the RU allocated by the sharing AP may only be within a BW of the PPDU carrying MU-RTS TXS, i.e. within the overlapped part of the operating channel of the shared AP and the operating channel of the sharing AP.

Timing diagram 510 shows the PPDU transmitted to share the TXOP. In examples, a plurality of PPDUs are transmitted to share a TXOP. The sharing AP may transmit a non-HT duplicate PPDU 512 having MU-RTS TXS duplicated in the overlapping channels 508 followed by the shared AP transmitting a non-HT duplicate PPDU 514 having CTS in response to the MU-RTS TXS duplicated in the overlapping channels 508. The CTS may indicate that the shared AP is ready to use the shared service period to transmit the PPDU and receive the TB PPDU. Based on the service period indicated in the MU-RTS TXS, the shared AP may transmit the non-HT duplicate PPDU 516 in the overlapping channels 508 of the shared AP during the indicated service period and receive a TB PPDU 518 in the overlapping channels 508 also during the shared service period.

In some examples, the shared AP may optionally use a bandwidth signaling mechanism to dynamically indicate the operating channel for transmitting a PPDU and TB PPDU within the TXOP sharing time period allocated to it by the sharing AP. The signaling may involve a sharing AP transmitting a PPDU indicating a MU-RTS TXS in each channel available for sharing. The shared AP may then send a PPDU with a CTS in each channel that the shared AP will use for transmitting a PPDU in the service period. The channels carrying the CTS may be a subset of the channels carrying the MU-RTS TXS. The shared AP may transmit the PPDU and TB-PPDU in the indicated channels having the CTS.

In an example, the BSS operating channel of the sharing AP may span a frequency of the BSS operating channel of the shared AP. In a time allocated by the sharing AP, the shared AP may not use the 20 MHz channel(s) that are not within a frequency of its BSS operating channel.

Punctured channels are channels in an BSS operating bandwidth are not used by a station. The punctured channels may not be used by an AP because of interference in those channels. The sharing AP and the shared AP may announce which channels in its BSS operating bandwidth are punctured in a respective beacon frame or action frame.

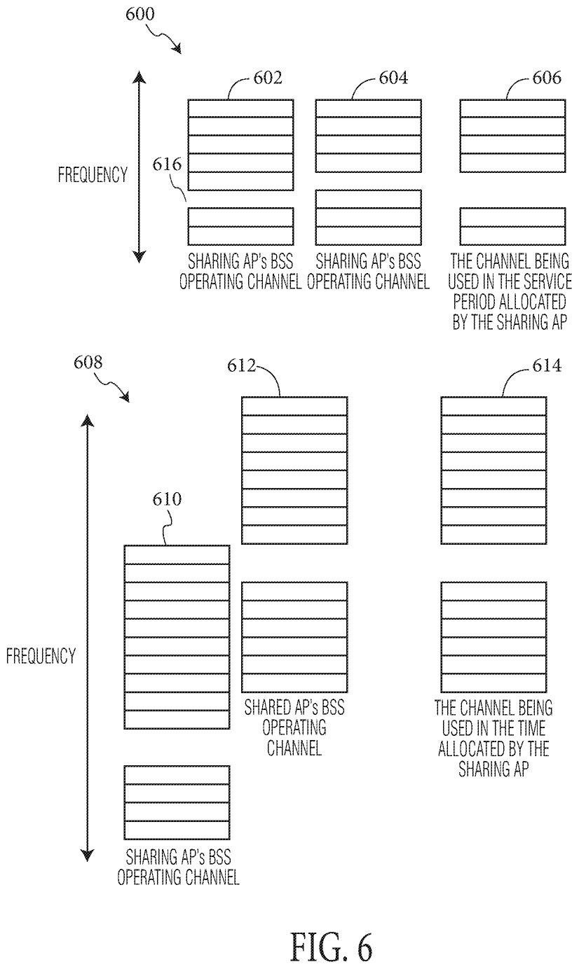

FIG. 6 illustrates an example of channel use in presence of puncturing in accordance with an embodiment. If both the sharing AP and the shared AP announce the channel puncture, and the shared AP does the frame exchanges with its associated STAs in the allocated service period, the shared AP may not allocate a RU in the punctured 20 MHz channels announced by both the sharing AP and shared AP.

Frequency spectrum 600 illustrates available channels of the shared AP and sharing AP in presence of puncturing when both a sharing AP and the shared AP may use a same 160 MHz channel. The sharing AP may announce that the third 20 MHz channel is punctured and the shared AP may announce that the 4^{th} 20 MHz channel is punctured. The punctured channel is indicated by absence of an illustrated channel between illustrated channels, an example which is shown by channel gap 616. The sharing AP may have operating channels 602 and the shared AP may have operating channels 604. In this case, if the sharing AP allocates 160 MHz to the shared AP, the shared AP may use the 160 MHz of channels with 3^{rd} and 4^{th} 20 MHz channels being punctured shown by the operating channels 606. In another example, a frequency spectrum 608 has a 320 MHz sharing AP and the 320 MHz shared AP with 160 MHz of channels overlapped with each other. Further, the frequency of the shared AP's 320 MHz of channels may be higher than the frequency of the sharing AP's 320 MHz of channels. The sharing AP may have operating channels 610 and the shared AP may have operating channels 612. The sharing AP may announce that the 40 MHz channel in secondary 80 MHz channel is punctured and the shared AP may announce that the 40 MHz channel in secondary 80 MHz channel is punctured. In this case, if the shared AP decides to use 320 MHz within the time period allocated by the sharing AP, the shared AP may use the 320 MHz of channels with 40 MHz channel in secondary 80 MHz channel being punctured shown by operating channels 614 and not used for frame transmission.

In some aspects, one or more of the sharing AP and shared AP may determine and store “static” punctured channel information. The static punctured channel information may indicate one or more 20 MHz channels that are likely to be busy or otherwise occupied in a relatively constant or consistent manner (such as by devices in an overlapping basic service set (OBSS)). In some other aspects, one or more of the sharing AP and shared AP may determine and store “dynamic” punctured channel information. The dynamic punctured channel information may indicate one or more channels that are likely to be busy or otherwise occupied in a relatively constant or consistent manner (such as by devices in an overlapping basic service set (OBSS)) and in some cases in addition to the channels indicated by the static punctured channel information). Based on determining the static and/or dynamic punctured channel information, one or more of the shared AP and sharing AP avoids transmitting wireless communications on portions of a wireless channel that are likely to encounter significant interference. For example, a shared AP or sharing AP may puncture one or more 20 MHz channels of the wireless channel when transmitting data to a station, thereby avoiding interference on the punctured subchannels while still utilizing the remainder of the available spectrum. Aspects of the present disclosure recognize that some channel conditions are likely to change over time, and that the channel conditions perceived by the shared AP may be different than the channel conditions perceived by the station which the shared AP communicates. In some examples, the MU-RTS TXS and CTS might indicate dynamic puncturing. The shared AP does not use punctured channels announced by the shared AP and the sharing AP.

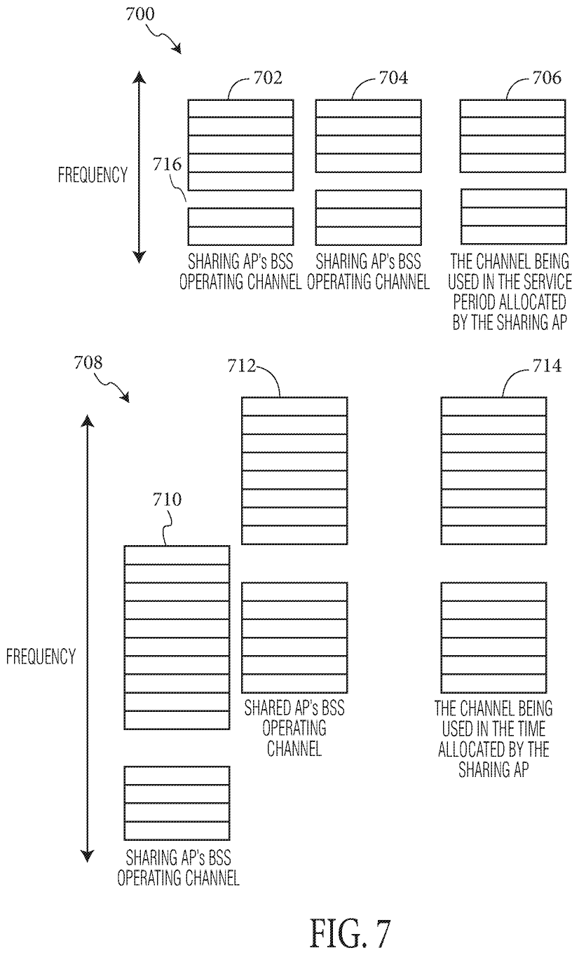

FIG. 7 illustrates another example of channel use in presence of puncturing in accordance with an embodiment. If both the sharing AP and the shared AP announce the channel puncture and the shared AP does the frame exchanges with its associated STAs in the allocated service period, the shared AP may allocate RU in the punctured 20 MHz channels announced by the shared AP only. Frequency spectrum 700 illustrates available channels of the shared AP and sharing AP in presence of puncturing when both a sharing AP and the shared AP may use a same 160 MHz channel. The sharing AP may announce that the third 20 MHz channel is punctured as shown by a channel gap 716 and the shared AP may announce that the 4^{th} 20 MHz channel is punctured. The sharing AP may have operating channels 702 and the shared AP may have operating channels 704. In this case, if the sharing AP allocates 160 MHz to the shared AP, the shared AP may use the 160 MHz of channels with the 4^{th} 20 MHz channels being punctured shown by the operating channels 706. In another example, a frequency spectrum 708 has a 320 MHz sharing AP and the 320 MHz shared AP with the 160 MHz of channels overlapped with each other. Further, the frequency of the shared AP's 320 MHz of channels may be higher than the frequency of the sharing AP's 320 MHz of channels. The sharing AP may have operating channels 710 and the shared AP may have operating channels 712. The sharing AP may announce that the 40 MHz channel in the secondary 80 MHz channel is punctured and the shared AP may announce that the 40 MHz channel in the secondary 80 MHz channel is punctured. In this case, if the sharing AP allocates 320 MHz of channels to the shared AP, the shared AP may use the 320 MHz of channels with 40 MHz channel in secondary 80 Mz channel being punctured shown by operating channels 714 and not used for frame transmission.

In some examples, the MU-RTS TXS and CTS might not indicate dynamic puncturing. The shared AP does not use punctured channels announced by the shared AP but may use punctured channels indicated by the sharing AP.

In an example, the sharing AP uses the shared AP's BSS operating channel and channel puncture information of the sharing AP to decide the possible bandwidth and channel puncture of the PPDU which carries the soliciting control frame (e.g. MU-RTS TXS).

In an example, the sharing AP uses the sharing AP's BSS operating channel and channel puncture information of the sharing AP to decide the possible bandwidth and channel puncture of the PPDU which carries the soliciting control frame (e.g. MU-RTS TXS).

The sharing AP may use dynamic channel puncture and indicate the possible bandwidth and channel puncture information in the PPDU which carries the soliciting control frame (e.g. MU RTS TXS). For example, the channels which are dynamically punctured are not used to carry the MU-RTS TXS and indicate the shared bandwidth in the service period. In another example, the sharing AP may not use dynamic channel puncture to indicate the possible bandwidth and channel puncture information in the PPDU which carries the soliciting control frame (e.g. MU RTS TXS). Under this option, the TXOP sharing among APs may not be allowed if the sharing AP and the shared AP have the different static punctured 20 MHz channels in the same bandwidth.

In order for a sharing AP to allocate part of its TXOP to a shared AP, the sharing AP may use a scheduling channel with a bandwidth defined by the sharing AP's bandwidth capability and the sharing AP's primary 20 MHz channel. The scheduling channel of the sharing AP may span a frequency of the primary 20 MHz channel of shared AP. Further, the scheduling channel of the shared AP may span a frequency of the primary 20 MHz channel of sharing AP.

The primary channel of the sharing AP and shared AP may be announced in a respective beacon frame. Further, the sharing AP and shared AP may not have the same primary 20 MHz channel. The primary channels are the same if they span a same frequency range and different if they do not span a same frequency range. The primary 20 MHz channel of the shared AP shall be within the BSS operating channel of the sharing AP. The primary 20 MHz channel of the sharing AP shall be within the BSS operating channel of the shared AP. The primary 20 MHz channel of the shared AP shall be within the BSS operating channel of the sharing AP and is not a punctured 20 MHz channel of the sharing AP. The primary 20 MHz channel of the sharing AP shall be within the BSS operating channel of the shared AP and is not a punctured 20 MHz channel of the shared AP. To avoid the shared AP and sharing AP having a same primary channel or two or more shared AP having a same primary channel in a same service period, one or more of the shared AP and sharing AP may perform a channel switch when a service period is used by both the sharing AP and shared AP in different operating channels.

In one example, one of the sharing AP or shared AP may negotiate a primary channel switch so that different 20 MHz channels are used for the primary channel of the sharing AP and shared AP to receive and decode management and control information during a service period. The channel switch may be performed in a channel switch element announcement included in the Beacon frame or Probe response. One or more of the switched channel and additional padding time for the switch are negotiated. If the switch is required for a sharing AP's associated STAs, then the sharing AP announces the switch in its Beacon and STAs associated with the sharing/shared AP do the switch when it detects a shared OFDMA schedule which indicates when RUs are available for usage by the STA.

Alternatively, when the sharing AP and at least one shared AP have the same primary 20 MHz channel, only one of them can transmit in the allocated service period of the TXOP. For example, a service period of the TXOP may be allocated to the shared AP or a service period of the TXOP may be allocated to the sharing AP and the other shared APs have different primary 20 MHz channels among them.

If shared APs have a same primary 20 MHz channel, then the primary channel of the shared AP is switched to allow for TXOP sharing in a same service period. The shared APs may negotiate a primary channel switch so that different 20 MHz channels are used for the primary channel for the different shared APs in the same service period. One or more of the switched channel and additional padding time for the switch are negotiated between the shared APs. If the switch is required for a shared AP's associated STAs, then the shared AP announces the switch in its Beacon and STAs associated with the shared AP do the switch when it detects a shared OFDMA schedule which indicates when RUs are available for usage by the STA.

Alternatively, when the shared APs have the same primary 20 MHz channel, only one of them can transmit in the allocated service period of the TXOP. For example, a service period of the TXOP may be allocated to the shared AP or a service period of the TXOP may be allocated to the sharing AP and the other shared APs have different primary 20 MHz channels among them.

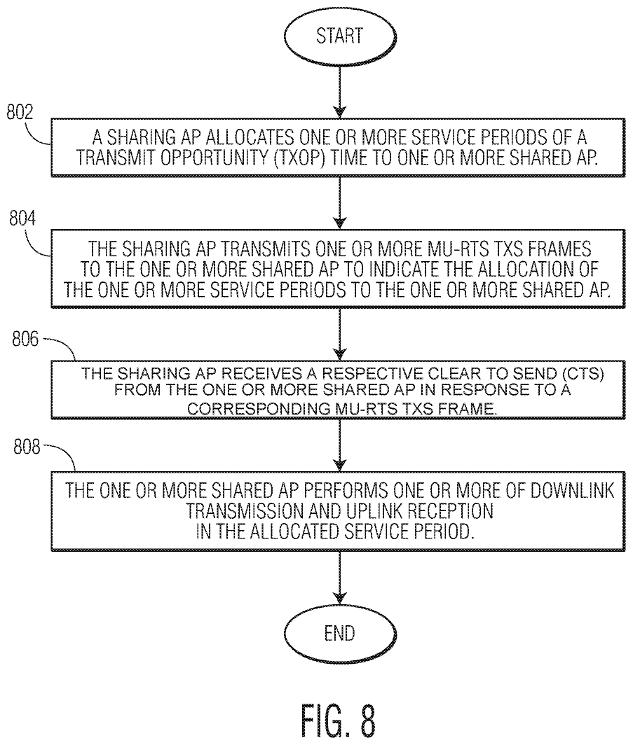

FIG. 8 illustrates a flow chart 800 of functions associated with sharing of a TXOP in accordance with an embodiment. At step 802, a sharing AP allocates one or more service periods of a transmit opportunity (TXOP) time to one or more shared AP. At step 802, the sharing AP transmits one or more MU-RTS TXS frames to the one or more shared AP to indicate the allocation of the one or more service periods to the one or more shared AP. The allocation may be indicated by the MU-RTS TXS frames which are duplicated in a plurality of channels that define channels to be used by a shared AP to transmit a PPDU. At step 806, the sharing AP receives a respective clear to send (CTS) from the one or more shared AP in response to a corresponding MU-RTS TXS frame to indicate the confirmation of the shared AP which will use the service period of the TXOP. At step 808, the one or more shared AP performs one or more of downlink transmission and uplink reception in the allocated service period. Advantageously, a throughput in the wireless network is increased by allowing a medium time of the TXOP to be shared among the APs in the wireless network in an OBSS.

In an embodiment, a method is disclosed. The method comprises: allocating, by a sharing access point, one or more service periods of a transmit opportunity (TXOP) time to one or more shared AP; transmitting, by the sharing access point, one or more multi-user request to send TXOP sharing (MU-RTS TXS) frames to the one or more shared AP to indicate the allocation of the one or more service periods; and receiving a respective clear to send (CTS) from the one or more shared AP in response to a corresponding MU-RTS TXS frame to indicate a confirmation by a respective shared AP which will use the allocated service period of the TXOP, wherein the one or more shared AP performs one or more of a downlink transmission and uplink reception in the allocated service period. In an example, the one or more service periods is one service period, and one or more shared AP is one shared AP. In an example, the one or more service periods is one service period, and one or more shared AP is two or more shared APs. In an example, the one or more service periods is two or more service periods, and one or more shared AP is two or more shared APs, wherein one shared AP is allocated to a respective service period. In an example, the method further comprises determining the one or more shared AP have a same 20 MHz primary channel as the sharing AP; and performing channel switch of a primary channel of one of the one or more shared APs during a service period. In an example, the method further comprises determining the one or more shared AP have a same 20 MHz primary channel as the sharing AP; and allocating the service period to only one of the one or more shared APs. In an example, the MU-RTS TXS frame indicates a respective service period for a respective shared AP in a respective User Information field of the MU-RTS TXS frame. In an example, the MU-RTS TXS frame indicates by an association identifier (AID) in a respective User Information field of the MU-RTS TXS frame the one or more shared AP. In an example, the MU-RTS TXS frame indicates a resource unit (RU) allocated to a respective shared AP in a User Information field of the MU-RTS TXS. In an example, the shared AP uses a basic service set (BSS) operating channel of the shared AP in the service period. In an example, the shared AP uses 20 MHz channels of the shared AP that overlaps in frequency with the BSS operating channel of the sharing AP and a respective primary channel of the shared AP and sharing AP are within a BSS operating channel of the shared AP and the BSS operating channel of the sharing AP. In an example, the operating channels exclude punctured channels of one or more of the shared AP and sharing AP. In an example, the method further comprises receiving, by the sharing AP from a respective shared AP, a request for allocation of a bandwidth and medium time of the TXOP. In an example, the MU-RTS TXS frame is duplicated in each channel of the BSS operating channel of the sharing AP and the CTS is received in each channel which the shared AP will use for the one or more of the downlink transmission and uplink reception in the allocated service period.

In another embodiment, a sharing access point (AP) is disclosed, The sharing AP is arranged to allocate one or more service periods of a transmit opportunity (TXOP) time to one or more shared AP; transmit one or more multi-user request to send TXOP sharing (MU-RTS TXS) frames to the one or more shared AP to indicate the allocation of the one or more service periods; and receive a respective clear to send (CTS) from the one or more shared AP in response to a corresponding MU-RTS TXS frame to indicate a confirmation by a respective shared AP which will use the allocated service period of the TXOP, wherein the one or more shared AP performs one or more of a downlink transmission and uplink reception in the allocated service period. In an example, the MU-RTS TXS frame is duplicated in each channel of the BSS operating channel of the sharing AP. In an example, the MU-RTS TXS frame indicates a respective service period is shared with a respective shared AP in a respective User Information field of the MU-RTS TXS frame. In an example, the MU-RTS TXS frame indicates the one or more shared AP in a User Information field of the MU-RTS TXS frame. In an example, the MU-RTS TXS frame indicates a resource unit (RU) allocated to a respective shared AP in a User Information field of the MU-RTS TXS frame. In an example, the MU-RTS TXS frame is duplicated in each channel of the BSS operating channel of the sharing AP and the CTS is received in each channel which the shared AP will use for the one or more of the downlink transmission and uplink reception in the allocated service period.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof: including potentially a program operable to cause one or more data processing apparatus such as a processor to perform the operations described (such as program code encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

What is claimed is:

1. A method comprising:
allocating, by a sharing access point, one or more service periods of a transmit opportunity (TXOP) time to one or more shared AP;
transmitting, by the sharing access point, one or more multi-user request to send TXOP sharing (MU-RTS TXS) frames to the one or more shared AP to indicate the allocation of the one or more service periods; and
receiving a respective clear to send (CTS) from the one or more shared AP in response to a corresponding MU-RTS TXS frame to indicate a confirmation by a respective shared AP which will use the allocated service period of the TXOP, wherein the one or more shared AP performs one or more of a downlink transmission and uplink reception in the allocated service period.

2. The method of claim 1, wherein the one or more service periods is one service period, and one or more shared AP is one shared AP.

3. The method of claim 1, wherein the one or more service periods is one service period, and one or more shared AP is two or more shared APs.

4. The method of claim 1, wherein the one or more service periods is two or more service periods, and one or more shared AP is two or more shared APs, wherein one shared AP is allocated to a respective service period.

5. The method of claim 1, further comprising determining the one or more shared AP have a same 20 MHz primary channel as the sharing AP; and performing channel switch of a primary channel of one of the one or more shared APs during a service period.

6. The method of claim 1, further comprising determining the one or more shared AP have a same 20 MHz primary channel as the sharing AP; and allocating the service period to only one of the one or more shared APs.

7. The method of claim 1, wherein the MU-RTS TXS frame indicates a respective service period for a respective shared AP in a respective User Information field of the MU-RTS TXS frame.

8. The method of claim 1, wherein the MU-RTS TXS frame indicates by an association identifier (AID) in a respective User Information field of the MU-RTS TXS frame the one or more shared AP.

9. The method of claim 1, wherein the MU-RTS TXS frame indicates a resource unit (RU) allocated to a respective shared AP in a User Information field of the MU-RTS TXS.

10. The method of claim 1, wherein the shared AP uses a basic service set (BSS) operating channel of the shared AP in the service period.

11. The method of claim 1, wherein the shared AP uses 20 MHz channels of the shared AP that overlaps in frequency with the BSS operating channel of the sharing AP and a respective primary channel of the shared AP and sharing AP are within a BSS operating channel of the shared AP and the BSS operating channel of the sharing AP.

12. The method of claim 11, wherein the operating channels exclude punctured channels of one or more of the shared AP and sharing AP.

13. The method of claim 1, further comprising receiving, by the sharing AP from a respective shared AP, a request for allocation of a bandwidth and medium time of the TXOP.

14. The method of claim 1, wherein the MU-RTS TXS frame is duplicated in each channel of the BSS operating channel of the sharing AP and the CTS is received in each channel which the shared AP will use for the one or more of the downlink transmission and uplink reception in the allocated service period.

15. A sharing access point (AP) arranged to allocate one or more service periods of a transmit opportunity (TXOP) time to one or more shared AP; transmit one or more multi-user request to send TXOP sharing (MU-RTS TXS) frames to the one or more shared AP to indicate the allocation of the one or more service periods; and receive a respective clear to send (CTS) from the one or more shared AP in response to a corresponding MU-RTS TXS frame to indicate a confirmation by a respective shared AP which will use the allocated service period of the TXOP, wherein the one or more shared AP performs one or more of a downlink transmission and uplink reception in the allocated service period.

16. The sharing AP of claim 15, wherein the MU-RTS TXS frame is duplicated in each channel of the BSS operating channel of the sharing AP.

17. The sharing AP of claim 15, wherein the MU-RTS TXS frame indicates a respective service period is shared with a respective shared AP in a respective User Information field of the MU-RTS TXS frame.

18. The sharing AP of claim 15, wherein the MU-RTS TXS frame indicates the one or more shared AP in a User Information field of the MU-RTS TXS frame.

19. The sharing AP of claim 15, wherein the MU-RTS TXS frame indicates a resource unit (RU) allocated to a respective shared AP in a User Information field of the MU-RTS TXS frame.

20. The sharing AP of claim 15, wherein the MU-RTS TXS frame is duplicated in each channel of the BSS operating channel of the sharing AP and the CTS is received in each channel which the shared AP will use for the one or more of the downlink transmission and uplink reception in the allocated service period.
